(19) United States
(12) Patent Application Publication
(10) Pub. No.: US 2009/0189978 A1
(43) Pub. Date: Jul. 30, 2009

(54) MEDICAL SUPPORT CONTROL SYSTEM

(75) Inventors: Koichi TASHIRO, Sagamihara (JP); Masaru ITO, Yokohama (JP)

Correspondence Address: OSTROLENK FABER GERB & SOFFEN, 1180 AVENUE OF THE AMERICAS, NEW YORK, NY, 100368403, US

(73) Assignee: Olympus Medical Systems Corp., Tokyo (JP)

(21) Appl. No.: 12/021,696

(22) Filed: Jan. 29, 2008

(51) Int. Cl. H04N 7/18; H04N 9/47

(52) U.S. Cl. 348/74; 348/75; 348/E07.085; 348/E09.033

(57) ABSTRACT

A medical device, comprising: a plurality of video interface cards are used for the medical support control system for converting, when a video signal is input from an external environment, a video signal input from the external environment into a common signal and vice versa, said common signal being different from any video signals input into and output from the video interface cards and said common signal being used commonly in the medical support control system; a switching control card for selecting, from among the video interface cards, a video interface card as an output destination in accordance with an instruction given from an external environment; and a plurality of video processing cards are used for the medical support control system for processing the common signal into a video signal appropriate to the selected video interface card on the basis of a video signal expressed by the common signal.

### BACKGROUND OF THE INVENTION

1. Field of the Invention

The present invention relates to a medical support control system for controlling medical devices and non-medical devices used for operations.

2. Description of the Related Art

Operating systems using medical controllers or the like for controlling medical devices such as endoscopes or the like used for operations have been proposed. Medical devices to be controlled such as electric knives, insufflation devices, endoscope cameras, light source devices, or the like are connected to the medical controller (also referred to as MC). Also, a display device, a manipulation panel, or the like is connected to the MC. The manipulation panel includes a display unit and a touch sensor, and is used as a central manipulation device by nurses or the like working in an unsterilized area. The display device is used for displaying endoscope images or the like.

There is audio-visual equipment in the operating room such as a room light, a room camera, an interphone device, a liquid crystal display device, or the like (non-medical devices). The audio-visual equipment is controlled independently or by a non-medical controller (also referred to as an NMC) used for the central control.

Japanese Patent Application Publication No. 2006-000536, for example, discloses an operating system, comprising:

a first controller connected to a medical device provided in an operating room;

a second controller connected to a non-medical device provided in the operating room; and

manipulation instruction input means transmitting the content of a manipulation instruction to the first controller when the manipulation instruction to the medical device or the non-medical device is input. The first controller transmits to the second controller a first control signal in accordance with the manipulation instruction of the non-medical device input into the manipulation instruction means. The second controller converts the first control signal into a second control signal used for controlling the non-medical device, and transmits the second control signal to the non-medical device. Thereby, the operating system and a non-medical system work together, and the operating person himself/herself or the like can manipulate the non-medical devices.

### SUMMARY OF THE INVENTION

A medical support control system that can control a medical device, comprising:

a plurality of video interface cards that are detachable from the medical support control system and that are used for the medical support control system for converting, when a video signal is input from an external environment, the video signal input from the external environment into a common signal and vice versa, said common signal being different from any of the video signals input into and output from the plurality of video interface cards and said common signal being used commonly in the medical support control system;

a switching control card for selecting, from among the video interface cards, a video interface card as an output destination in accordance with an instruction given from an external environment; and

a plurality of video processing cards that are detachable from the medical support control system and that are used for the medical support control system for processing a signal into a video signal appropriate to the selected video interface card on the basis of a video signal expressed by the common signal.

A plurality of video interface cards that are detachable from the medical support control system that is able to control a medical device and that are used for the medical support control system, comprising:

an input processing unit for inputting a video signal and an output processing unit for outputting a video signal;

a signal conversion unit for converting a common signal into the video signal and vice versa, said common signal being different from any of the video signals input into and output from the plurality of video interface cards and said common signal being used commonly in the medical support control system; and

a common signal input/output unit for inputting and outputting the common signal obtained by the conversion.

### BRIEF DESCRIPTION OF THE DRAWINGS

FIG. 1 shows an entire configuration of a medical device control system according to the present embodiment;

FIG. 2 is a block diagram showing an entire configuration of a medical support control system 100 according to the present embodiment;

FIG. 3 is a side view showing a configuration of the rear panel of an NMC according to the present embodiment;

FIG. 4 shows a configuration of a video interface card;

FIG. 5 shows a configuration of a switching control card;

FIG. 6 shows a configuration of a video processing card;

FIG. 7 shows a flow of signals when a video signal input from the VIC is output to the selected output-destination VIC via the SCC;

FIG. 8 shows a flow of signals when a video signal input from the VIC undergoes image processing in the VIP via the SCC, and is output to the selected output-destination VIC;

FIG. 9 shows a flow of signals when video signals input from a plurality of the VICs undergo image processing in the VIP via the SCC, and are output to the selected output-destination VIC;

FIG. 10 shows a configuration of an audio interface card;

FIG. 11 shows a flow of signals when audio signals input from a plurality of the AICs are output to the selected output-destination AIC via the SCC.

### DESCRIPTION OF THE PREFERRED EMBODIMENTS

Hereinafter, the embodiments of the present invention will be explained in detail, referring to the drawings.

A medical support control system according to the present embodiment includes a medical device control system and a non-medical device control system. The medical device control system includes a plurality of medical devices and a medical controller for controlling these medical devices. The non-medical device control system includes non-medical devices (that may further include medical devices) that are used for operations, and a non-medical controller for controlling these non-medical devices.

An endoscopic operating system will be explained as an example of the medical device control system.

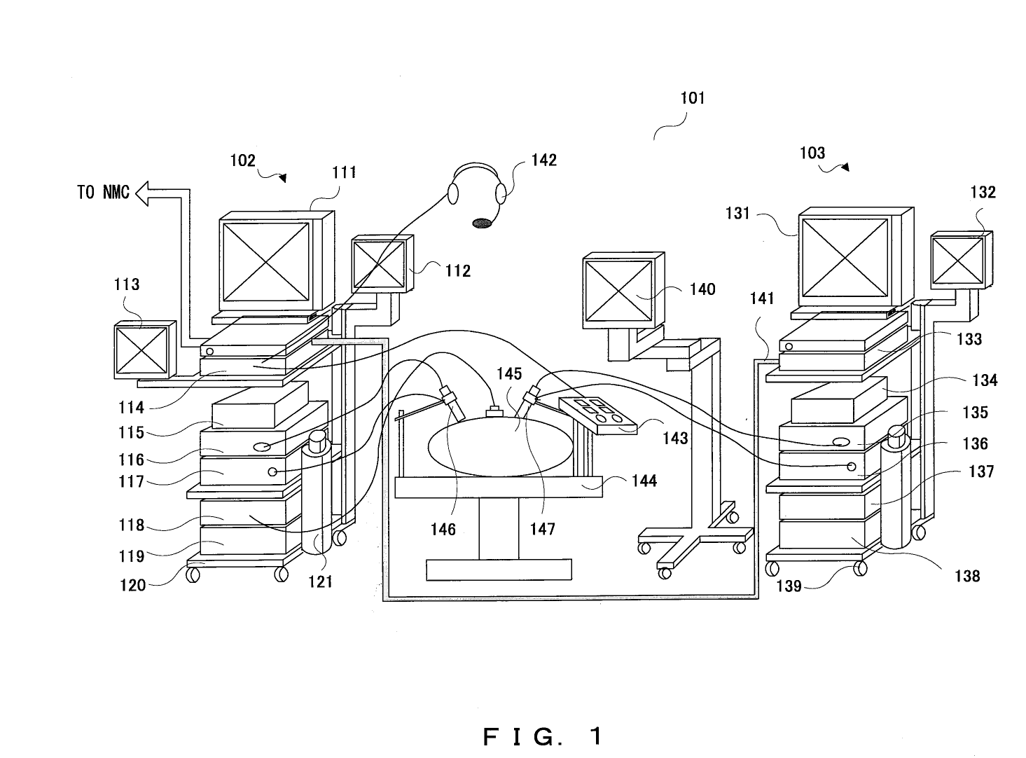

FIG. 1 shows an entire configuration of the medical device control system according to the present embodiment. An endoscopic operating system is shown as a medical device control system 101. In the operating room, a first endoscopic operating system 102 and a second endoscopic operating system 103 beside a bed 144 on which a patient 145 is laid and a wireless remote controller 143 for the operating person are provided.

The endoscopic operating systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a medical controller (MC) 114, a recorder 115, a video processor 116, an endoscope light source device 117, an insufflation unit 118, and an electrical surgical device 119 are arranged.

The central manipulation panel device 113 is arranged in a unsterilized area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the MC 114 via communication cables (not shown) such as serial interface cables or the like, and can have communications with one another.

Also, a headset-type microphone 142 can be connected to the MC 114. The MC 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The insufflation unit 118 provides CO₂ gas to the abdomen of the patient 145 through a tube. The CO₂ gas is obtained from a gas tank 121.

On the second trolley 139, an endoscope image display panel 131, a central display panel 132, a expansion unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the expansion unit 133 through cables (not shown), and can communicate with one another. The MC 114 and the expansion unit 133 are connected to each other through the expansion cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131.

Further, the MC 114 can be controlled by the operating person manipulating the devices in the unsterilized area. Also, the first and second trolleys 120 and 139 can include other devices such as printers, ultrasonic observation devices, or the like.

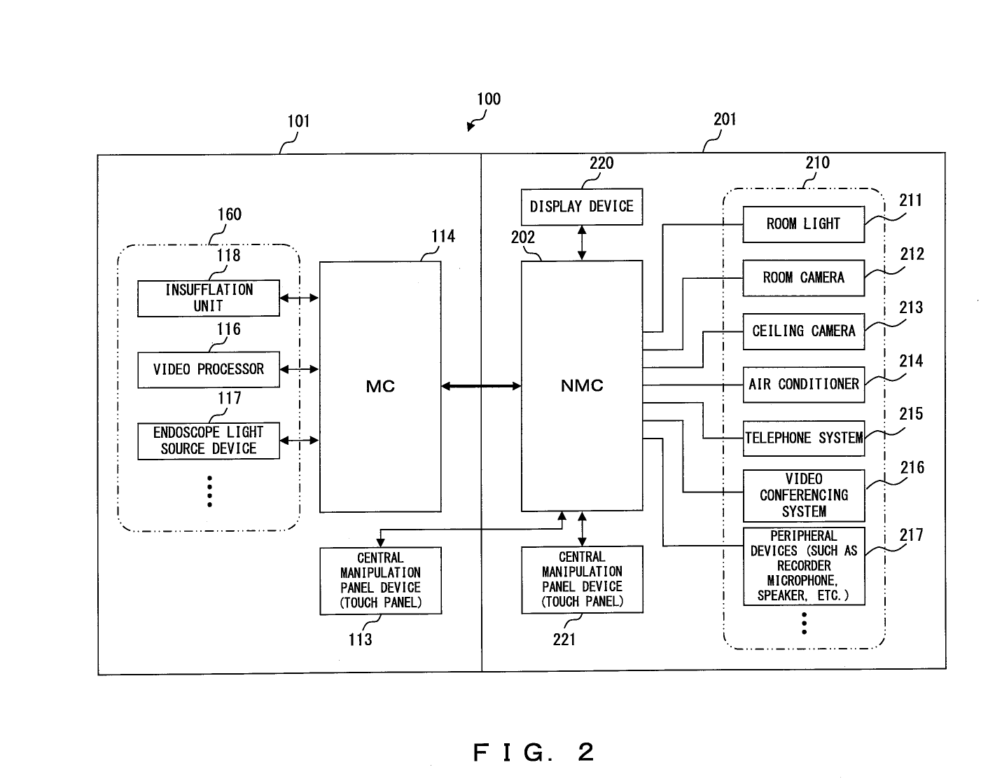

FIG. 2 is a block diagram showing an entire configuration of a medical support control system 100 according to the present embodiment. As described above, the medical support control system 100 includes the medical device control system 101 and a non-medical device control system 201. A detailed configuration of the medical device control system 101 is as shown in FIG. 1. However, in FIG. 2, the medical device control system 101 is shown in a simplified manner for simplicity of explanation.

In FIG. 2, a medical device group 160 is a group of medical devices that are directly connected to the medical controller 114 or are indirectly connected to the MC 114 via the expansion unit 133. Examples of the devices included in the medical device group 160 are the insufflation unit 118, the video processor 116, the endoscope light source device 117, the electrical surgical device 119, and the like.

The central manipulation panel device 113 has a touch panel, and in accordance with the information input into the touch panel, the devices connected to the MC 114 or a non-medical device controller (NMC) 202 that will be described later can be manipulated.

The non-medical control system 201 includes the NMC 202 connected to the MC 114 through a communication cable or the like, and a non-medical device group 210. In this configuration, the NMC 202 can transmit and receive, through an image cable, the video signals to and from the medical device group 160 connected to the MC 114.

The NMC 202 controls the non-medical devices (including the audio-visual devices) connected thereto. As shown in FIG. 2, the non-medical device group 210 connected to the NMC 202 according to the present embodiment consists of a room light 211, a room camera 212, a ceiling camera 213, an air conditioner 214, a telephone system 215, a conference system 216 to be used for individuals in remote places (referred to as a video conference system hereinafter), and other peripheral devices 217. Further, a display device 220 and a central manipulation panel device 221 are connected to the NMC 202.

Also, the non-medical device group 210 includes equipment such as light devices provided in the operating room in addition to the AV devices used for recording and reproducing image data.

The display device 220 is a plasma display panel (PDP) or a liquid crystal display (LCD) device, and displays images of the predetermined device or images of the devices selected by nurses or the like through the central manipulation panel device 221. The room light 211 is a device that illuminates the operating room. The room camera 212 is used for shooting images of the situations in the operating room. The ceiling camera 213 is a camera suspended from the ceiling whose positions can be changed. The conference system 216 is a system that displays images and transmits voices of nurses or the like in the medical office or the nurse stations, and enables conversations with them. The peripheral devices 217 are, for example, a printer, a CD player, a DVD recorder, and the like. The central manipulation panel device 221 has a touch panel that is the same as that included in the central manipulation panel device 113, and controls the respective AV devices connected to the NMC 202. The central manipulation panel devices 113 and 221 are referred to as TPs hereinafter.

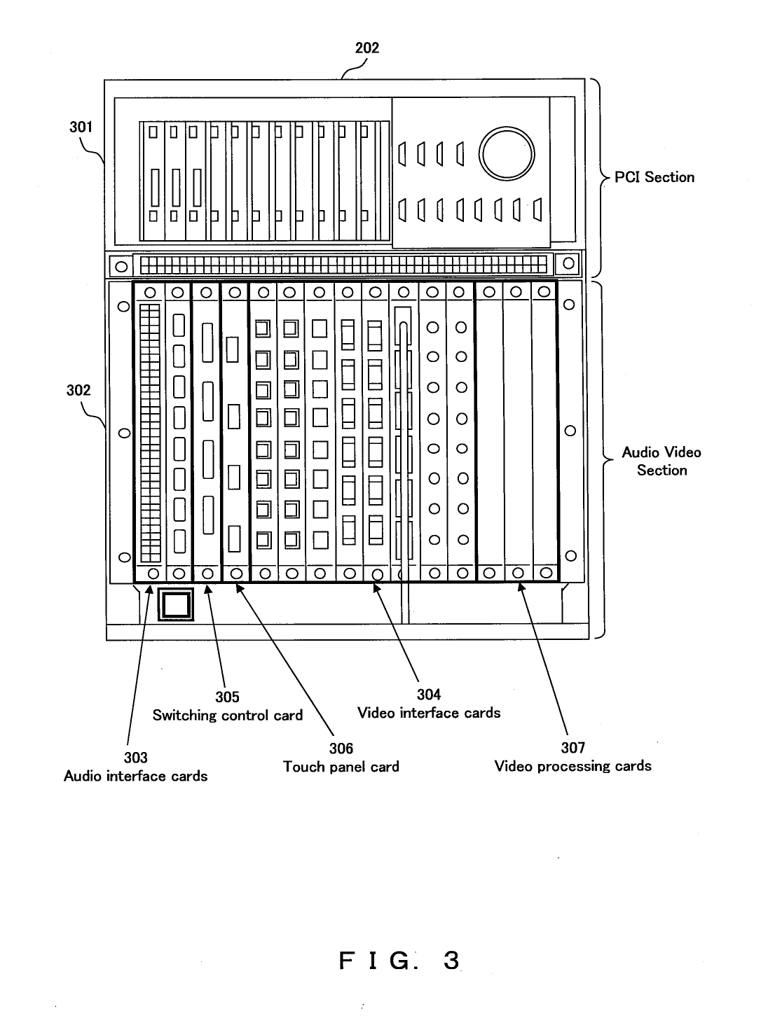

FIG. 3 is a side view showing a configuration of the rear panel of the NMC 202 according to the present embodiment.

The NMC 202 includes a PCI section 301 and an audio/video section 302.

The PCI section communicates with devices connected to the external environment, and has cards having relay devices and the functions of the RS232C, the digital I/O, the ether net, and the modem in order to control devices in the non-medical device group 210 that are connected to other cards that will be described later.

The audio/video section 302 includes audio interface cards 303 (AIC), video interface cards 304 (VIC), a switching control card 305 (SCC), a touch panel card 306 (TPC), and video processing cards 307 (VPC). Additionally, the respective cards included in the audio/video section 302 of the NMC 202 are detachable.

The AICs 303 are inserted into a plurality of slots for the AICs 303 in order to receive, process (amplify, for example), and output audio signals input from a device such as an IC or the like that includes a transmitter/receiver existing in the external environment.

Each of the VICs 304 creates, when a video signal is input into it from the external environment, a common signal, said common signal being different from any of the video signals input into and output from the VICs 304 and said common signal being used commonly in the NMC 202.

In this configuration, examples of the video signals include an HD/SD-SDI (High Definition/Standard Definition-Serial Digital Interface) signal, an RGB/YPbPr signal, an S-Video signal, a CVBS (Composite Video Blanking and Sync) signal, a DVI-I (Digital Visual Interface Integrated) signal, an HDMI (High-Definition Multimedia Interface) signal, and the like.

Also, the VICs 304 have a function of converting the common signals into video signals that are appropriate to the output destinations. Also, the VICs 304 can be inserted into a plurality of slots for the VICs 304. Also, the VICs 304 can have a common interface connector 405. Also, the VICs 304 use paths for directly outputting the input video signals without converting the signals when the VICs 304 are turned off.

The SCC 305 selects the VIC 304 as the output destination in accordance with instructions given from the external environment. Also, the SCC 305 obtains VIC-related information including identification information used for identifying the VICs 304 and position information specifying the positions of the corresponding VICs 304. The identification information is obtained from the VICs 304. Then, the SCC 305 detects, on the basis of the VIC-related information, the position of the VIC 304 as the output destination set in accordance with the instruction given from the external environment, selects the VIC 304 as the output destination for the common signal, and determines whether or not this output should be made via the VPC 307.

The SCC 305 is connected to the TP 221 via, for example, the TPC 306, and the manipulator sets, in the SCC 305, which of the VICs 304 is to be selected as the output destination and whether or not the output should be made via the VPC 307.

The VPC 307, in accordance with the video signals expressed by the common signals, processes the input signals into video signals appropriate to the selected VIC 304.

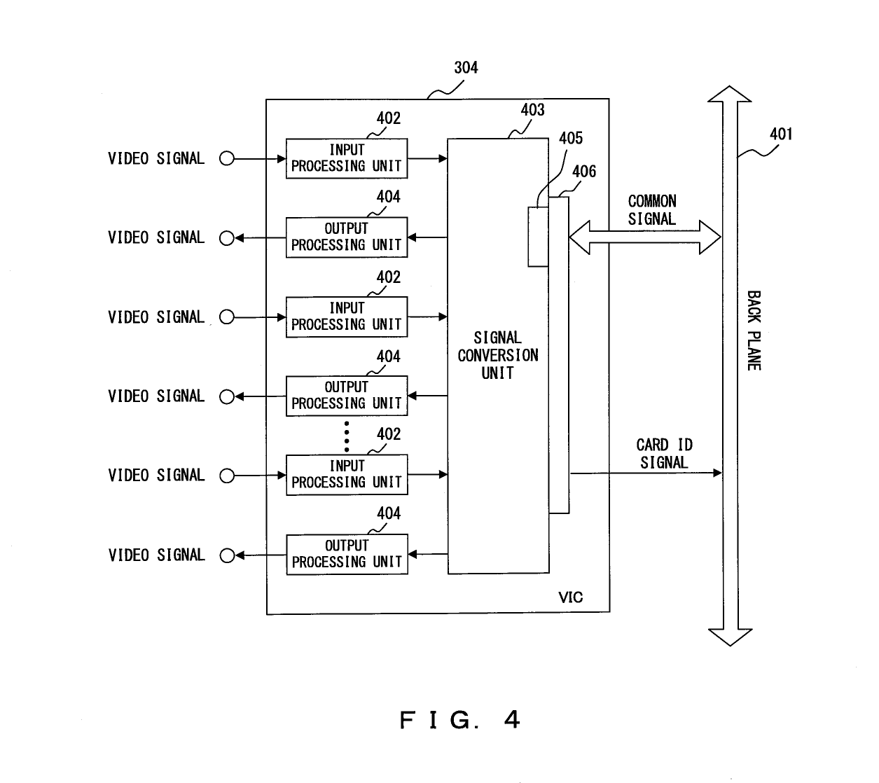

FIG. 4 shows a configuration of the VIC 304.

The VIC 304 is attached to a back plane 401, and includes an input processing unit 402, a signal conversion unit 403, an output processing unit 404, and a connector 405. In this configuration, the back plane 401 includes slots into which the audio interface cards (AIC) 303, the video interface cards (VIC) 304, the switching control card (SCC) 305, a touch panel card (TPC) 306, and the video processing cards (VPC) 307 are inserted. These cards perform communications via the back plane 401.

The VICs 304 transmit and receive, through the back plane 401, the common signals that are obtained by converting the video signals by using the signal conversion unit 403, the common signals input through the cards other than the VICs 304, the identification information for identifying the VICs 304, and the position information for specifying the positions of the slots into which the VICs have been inserted.

The input processing unit 402 receives the video signals output from devices (medical devices and non-medical devices) that are connected to the NMC 202 and are used for outputting video signals, and transfers the received video signals to the signal conversion unit 403.

The signal conversion unit 403 converts the common signal, said common signal being different from any of the video signals input into and output from the VICs 304 and said common signal being used commonly in the NMC 202, into video signals, and vice versa.

In other words, the signal conversion unit 403 converts the video signal input from the input processing unit 402 into the common signals, and out puts the common signals to the back plane 401. Also, the signal conversion unit 403 obtains the common signal input into the VICs 304 via the back plane 401, and converts the obtained signals into video signals appropriate to the selected VIC 304.

Also, the signal conversion unit 403 outputs, via the back plane 401, VIC-related information (a card ID signal) consisting of the identification information used for identifying the VIC 304 and the position information specifying the position of the slot into which the VIC 304 has been inserted.

The output processing unit 404 outputs the video signals obtained by the conversion of the common signal by using the signal conversion unit 403.

The common signal input/output unit 405 inputs and outputs the common signals obtained by the conversion by using the signal conversion unit 403 or the common signals input into the signal conversion unit 403 via the back plane 401.

A connector 406 is attached to the back plane 401. Also, the VICs 304 respectively have input/output terminals that correspond to different video signals from card to card; however, the connector 406 has its shape and pins arranged so that it can be connected to any of the slots for the VICs or the VPC of the back plane 401.

In the conventional techniques, the components of video signals (such as RGB color signals or synchronization signals such as H or V) have been processed independently, which has caused synchronization shifts due to the overtaking of the signals and has caused complexity in the artwork. However, by serializing the common signals that were obtained by the conversion in the VICs 304 as in the present example, artwork (wiring for a PCB) that does not cause the synchronization shifts can be realized easily.

Additionally, in order to be compatible with new image formats that may appear in the future, it is possible to design and manufacture a VIC that corresponds to the new image format and to set a new ID, and thereby the extension to the new format can be realized.

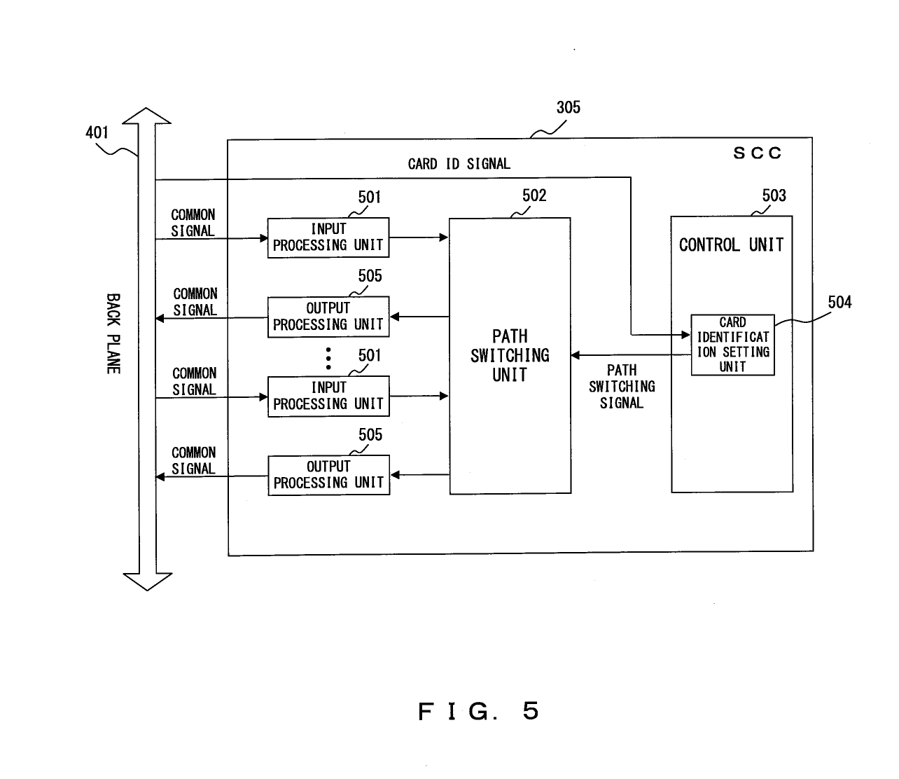

FIG. 5 shows a configuration of the SCC 305.

The SCC 305 is attached to the back plane 401, includes an input processing unit 501, a path switching unit 502, a control unit 503, and an output processing unit 505, and switches the paths for the serialized common signals.

The input processing unit 501 receives the common signals input from the back plane 401 and transfers the received signals to the path switching unit 502.

The path switching unit 502 switches the paths for the common signals. For example, the path switching unit 502 determines, on the basis of the path switching signals output from the control unit 503, the path for the common signal to be output to the output-destination VIC 304. Also, when image processing is to be performed in the VPC 307, the path switching unit 502 determines, on the basis of the path switching signal, the path for the common signal to be output to the output-destination VPC 307. Also, the path switching unit 502 determines the path to the VIC 304 for the common signal that is output from the VPC 307 after the image processing.

The control unit 503 has a card identification setting unit 504, transfers control signals output from an external connection device to the PCI section 301, and obtains control signals input from the PCI section 301 in order to control the respective units in the SCC 305.

The card identification setting unit 504 in the control unit 503 outputs path switching signals that are used for determining the output paths for the output-destination VIC 304 and the VPC 307 on the basis of the identification information and the position information of the VIC-related information (card ID information), and the selection information of the output-destination VIC 304 and the VPC 307 set in accordance with the control signals from the TPs 113 and 221.

In order to perform setting from the external environment, selection information for the output-destination VIC 304 is set in the card identification setting unit 504 from, for example, the TPs 113 and 221 in order to cause the input-destination VIC 304 and the output-destination VIC 304 to correspond to each other. By establishing this correspondence, the position of the output-destination VIC 304 is detected from the VIC-related information in order to determine the output-destination VIC 304 for the common signals.

The output processing unit 505 outputs, to the output-destination VIC 304 set in the above step, the common signals output from the path switching unit 502.

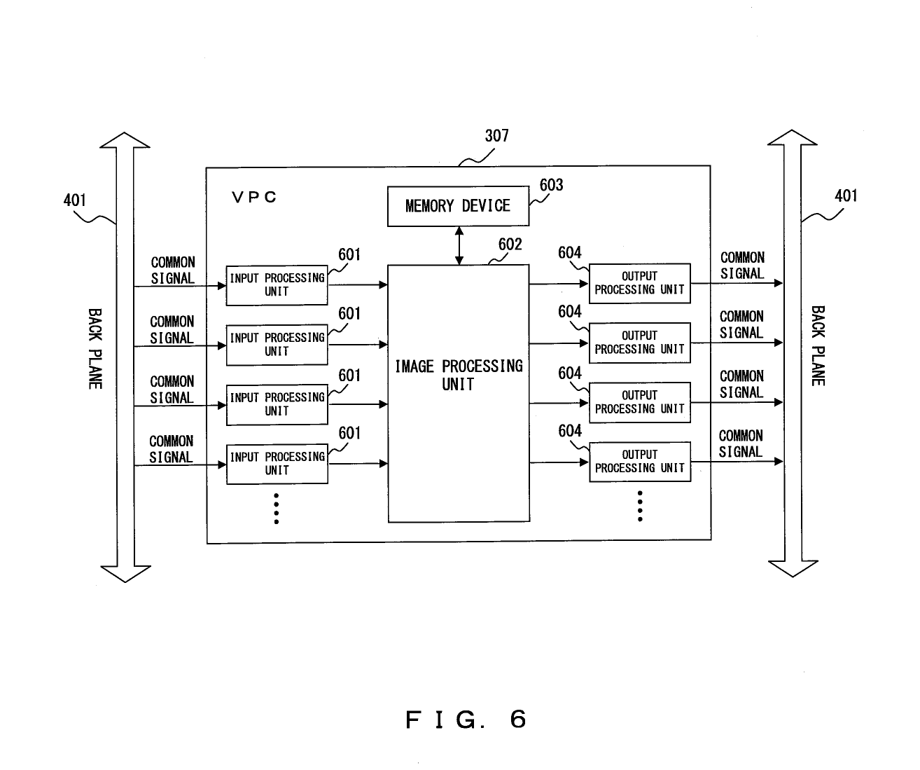

FIG. 6 shows a configuration of a VPC 307.

The VPCs are attached to the back plane 401, and include an input processing unit 601, an image processing unit 602, a memory device 603, and an output processing unit 604.

The input processing unit 601 receives the common signals input from the back plane 401, and transfers the received common signals to the image processing unit 602.

The image processing unit 602, on the basis of the video signals expressed by the common signals, processes the signals into video signals appropriate to the selected VIC 304, and also holds the common signals input from the input processing unit 601 in the memory device 603, and performs image processing on the held common signals in order to output the signals. It is also possible that the common signals undergo the image processing after being converted into the prescribed video signals.

The above image processing includes, for example, the de-interlacing, the rate control, the scaling, the mirror, the rotation, the picture in picture (PIP), the picture out picture (POP), and the like.

The output processing unit 604 transfers, to the SCC 305 via the back plane 401, the common signals that have undergone the image processing performed by the image processing unit 602.

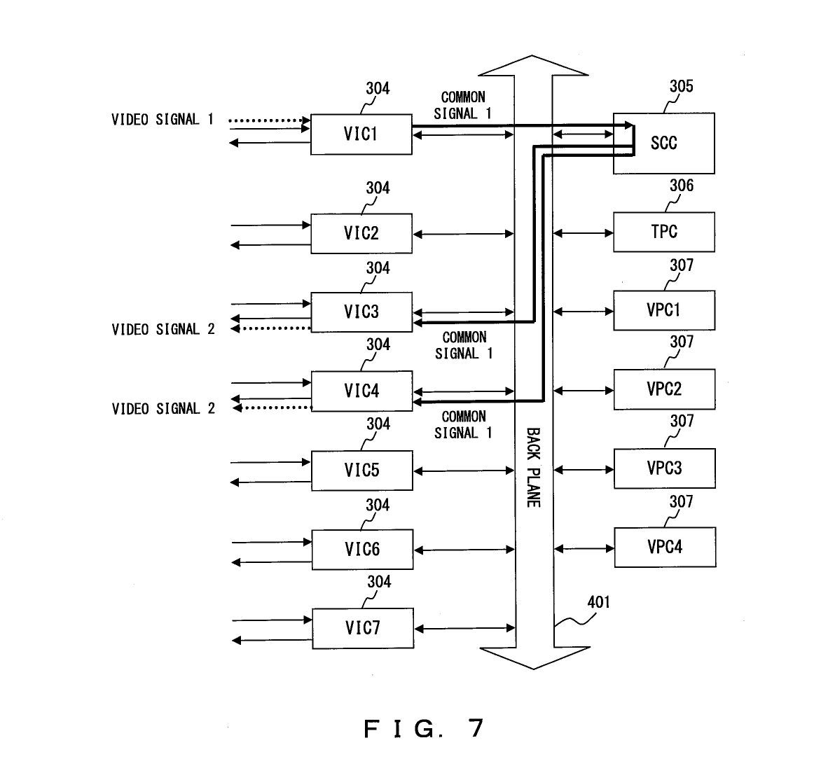

FIG. 7 shows a flow of signals when a video signal input from the VIC 304 is output to the selected output-destination VIC 304 via the SCC 305.

In FIG. 7, an input video signal 1 (represented by a dotted line) is input into a VIC1 304 and is converted into a common signal 1 (represented by a solid line). The converted common signal 1 is input, via the SCC 305, into an output-destination VIC3 304 that is set in advance and the VIC3 304 converts the common signal 1 to the prescribed video signal 2 (dotted line) in order to output the video signal.

It is also possible for the common signal 1 to be divided by the SCC 305 and the common signal 1 to also be input into the output-destination VIC4 304 that is set in advance, and thereafter for the common signal 1 to be converted into a prescribed video signal 2 (represented by a dotted line) in order to be output.

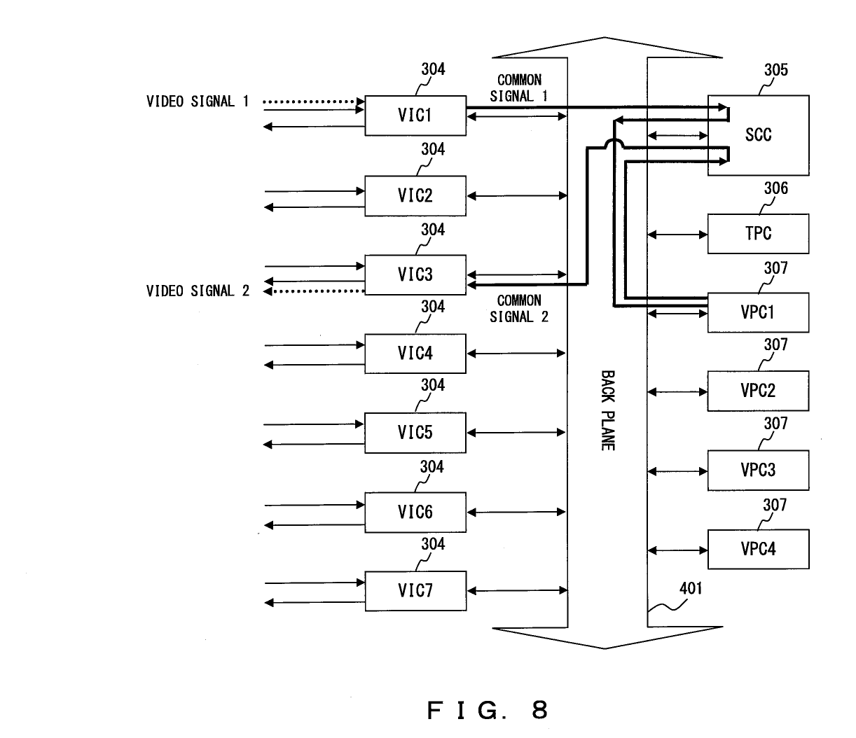

FIG. 8 shows a flow of signals when a video signal input from the VIC 304 undergoes image processing in the VIP 307 via the SCC 305, and is output to the selected output-destination VIC 304.

The video signal 1 (represented by a dotted line) input from an input terminal of the VIC 304 is input into the VIC1 304, and is converted into the common signal 1 (represented by a solid line). The common signal 1 obtained by the conversion is input into the SCC 305, and is input into the output-destination VPC1 307 set by the SCC 305 in advance. In the VPC1 307, signal conversion is performed in which a single video signal image is used or image conversion is performed on the common signal 1 in the VPC1 307. For example, image processing such as the de-interlacing, the rate control, the scaling, the mirror, the rotation, and the like is performed.

The VPC1 307 outputs, to the SCC 305, the common signal 2 obtained by the above signal conversion or the image conversion. The SCC 305 transfers, to the output-destination VIC3 304 set in advance, the common signal 2 obtained by the above signal conversion or the image conversion. The VIC3 304 converts, to the prescribed video signal 2 (represented by a dotted line), the common signal 2 obtained by the signal conversion, and outputs the signal.

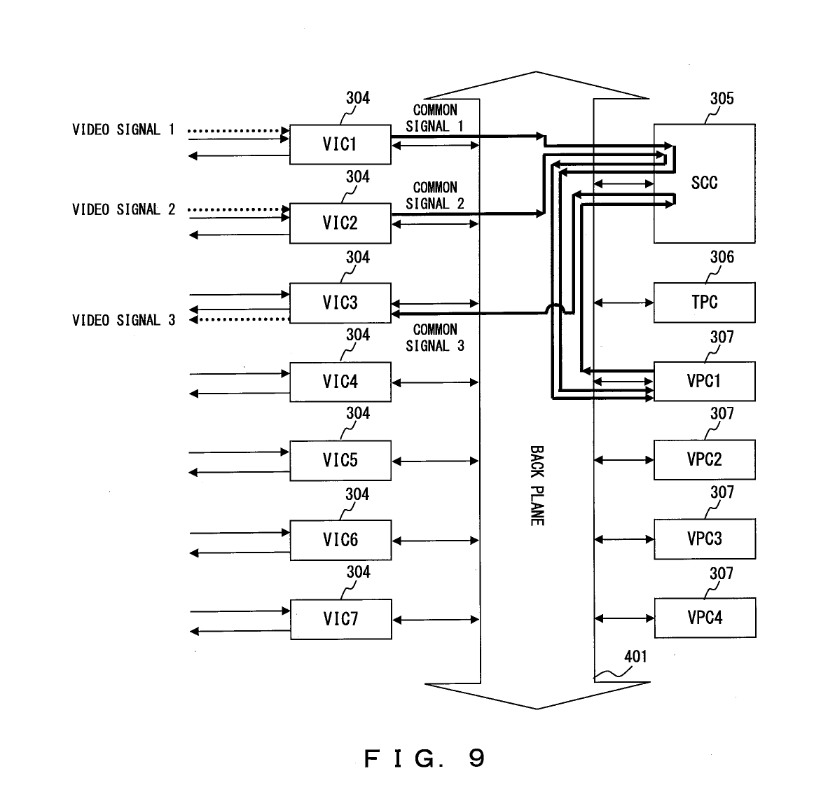

FIG. 9 shows a flow of signals when video signals input from a plurality of the VICs 304 undergo image processing in the VIP 307 via the SCC 305, and are output to the selected output-destination VIC 304.

The video signal 1 (represented by a dotted line) input through an input terminal of the VIC 304 is input into the VIC1 304, and is converted into the common signal 1 (represented by a solid line). Also, the video signal 2 (represented by a dotted line) is input into the VIC2 304, and then is converted into the common signal 2 (solid line).

The video signals 1 and 2 are respectively converted into the common signals land 2, and these common signals are input into the SCC 305 and are input into the output-destination VPC1 307 that is set in advance by the SCC 305. The VPC1 307 performs on these common signals 1 and 2 an image conversion such as picture in picture (PIP), picture out picture (POP), or the like in which a plurality of video signal images are used.

The VPC1 307 outputs to the SCC 305 a common signal 3 that was obtained by the above image conversion. The

SCC 305: outputs the common signal 3 to the output-destination VIC3 304. The VIC3 304 converts the common signal 3 into a prescribed video signal 3 (represented by a dotted line), and outputs the video signal 3.

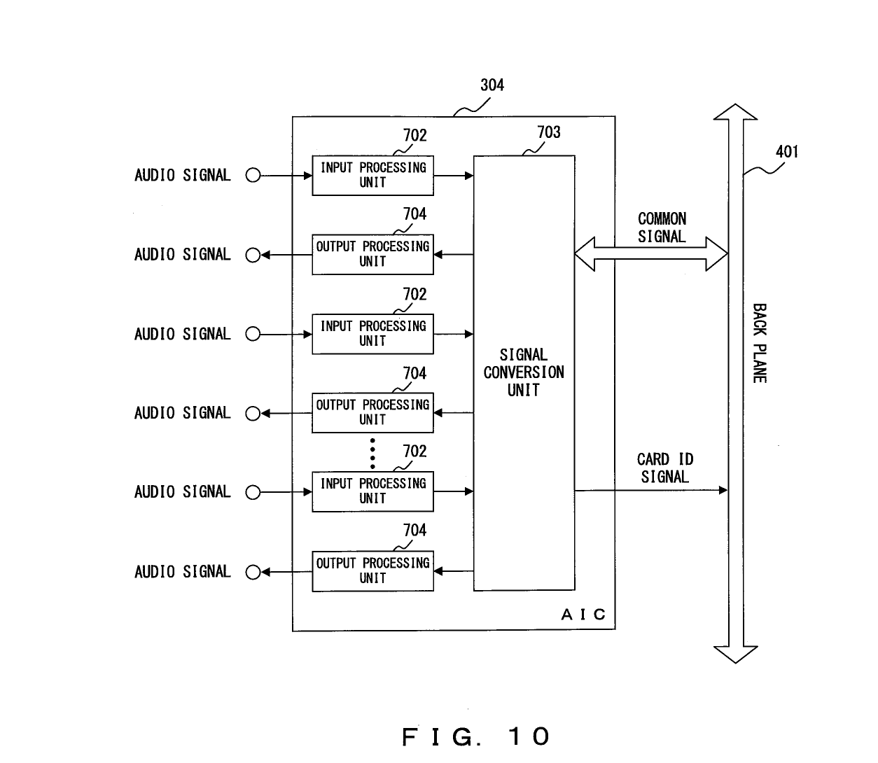

FIG. 10 shows a configuration of the AIC 303.

The AIC 303 is attached to the back plane 401, and includes an input processing unit 702, a signal conversion unit 703, and an output processing unit 704.

The AIC 303 transmits and receives, via the back plane 401, common signals that are audio signals converted by the signal conversion unit 703, common signals input from cards other than the AIC 303, identification information used for identifying the AIC 303, and position information specifying the position of the slot into which the AIC 303 itself is inserted.

The input processing unit 702 receives the audio signals output from the devices (medical device and non-medical devices) connected to the MC 114 and the NMC 202 to be used for outputting the audio signals, and transfers the received signals to the signal conversion unit 703.

The signal conversion unit 703 converts the common signal, said common signal being different from any of the audio signals input into and output from the AICs 303 and said common signal being used commonly in the NMC 202, into audio signals, and vice versa.

In other words, the signal conversion unit 703 converts into the common signals the audio signals input from the input processing unit 702, and outputs the signal obtained by the conversion to the back plane 401. Also, the signal conversion unit 703 obtains the common signals input into the AIC 303 via the back plane 401, and converts the obtained signals into desired audio signals.

Also, the signal conversion unit 703 outputs, via the back plane 401, AIC-related information (a card ID signal) consisting of the identification information used for identifying the AIC 303 and the position information specifying the position of the slot into which the AIC 303 has been inserted.

The output processing unit 704 outputs the audio signals obtained by converting the common signal by using the signal conversion unit 703.

By serializing the common signals that were obtained by the conversion in the AICs 303, artwork (wiring for a PCB) that does not cause synchronization shifts can be realized easily.

Additionally, in order to be compatible with new image formats that may appear in the future, it is possible to design and manufacture an AIC that corresponds to the new image format and to set a new ID, and thereby the extension to the new format can be realized.

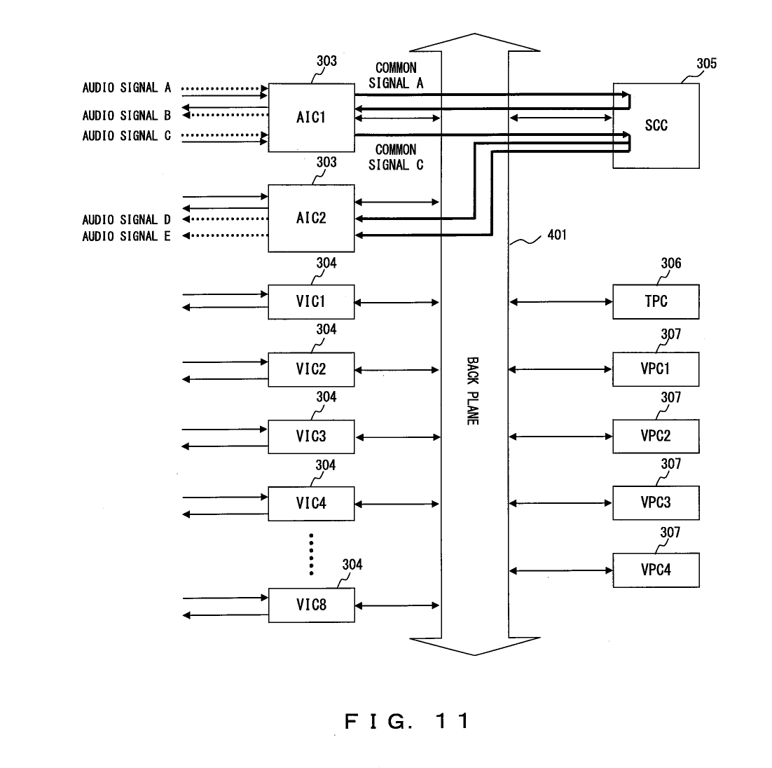

FIG. 11 shows a flow of signals when audio signals input from a plurality of the AICs 303 are output to the selected output-destination AIC 303 via the SCC 305.

In FIG. 11, an input audio signal A (represented by a dotted line) is input into an AIC1 303, and is converted into a common signal A (represented by a solid line). The common signal A obtained by the conversion is input, via the SCC 305, into the output-destination AIC1 303 that was set in advance. Then, the common signal A is converted into a prescribed audio signal B (represented by a dotted line), and the signal obtained by the conversion is output.

Also, an audio signal C (represented by a dotted line) is input into the AIC1 303, and is converted into a common signal C (represented by a solid line). The common signal C obtained by the conversion is input, via the SCC 305, into the output-destination AIC2 303 (different AIC) that is set in advance, is converted into a prescribed audio signal D (represented by a dotted line) or an audio signal E (represented by a dotted line), and is output.

By the above configuration, it is possible to provide a medical support control system for controlling medical devices and non-medical devices.

In the conventional techniques, a different number of inputs and outputs used for images and different image sources have been used depending upon the procedures performed or devices used, and because of this the systems have been large in size and the management of the systems has been complicated.

However, by the above configuration, connection to a plurality of external image conversion devices has become unnecessary and common image cards (such as the VIC and VPC) are employed, which reduces the system size.

Also, when a single device (the NMC 202 shown in FIG. 3) includes the VICs 304, it is possible to change the number of inputs and outputs used for video signals and the types (image sources) of video signals that can be used.

Also, by providing, in a single device, the VPCs 307 each of which can perform a plurality of image processes, it is possible to change the number of types of image processing by changing the VPCs 307 used as occasion.

Also, by using a common back plane and interface connectors that are not dependent on the types of VICs 304 or VPCs 307, it is possible to flexibly use the slots for the VICs 304 and the VPCs 307.

Also, in the conventional techniques, much time has been required to change designs in order to be compatible with new image formats, and external devices have been required, thereby the size of the systems has been large. However, in the present invention, common signals are used, and thereby it is possible to be compatible with new image formats that may appear in the future by designing only VICs that correspond to the new image formats without changing the design greatly.

The scope of the present invention is not limited to the above embodiments, and various alterations and modifications are allowed without departing from the spirit of the present invention.

What is claimed is:

1. A medical support control system that can control a medical device, comprising:
a plurality of video interface cards that are detachable from the medical support control system and that are used for the medical support control system for converting, when a video signal is input from an external environment, the video signal input from an external environment into a common signal and vice versa, said common signal being different from any video signals input into and output from the plurality of video interface cards and said common signal being used commonly in the medical support control system;
a switching control card for selecting, from among the video interface cards, a video interface card as an output destination in accordance with an instruction given from an external environment; and
a plurality of video processing cards that are detachable from the medical support control system and that are used for the medical support control system for processing the common signal into a video signal appropriate to the selected video interface card on the basis of a video signal expressed by the common signal.

2. The medical support control system according to claim 1, wherein:
the common signal is a serial signal.

3. The medical support control system according to claim 1, wherein:
all of the respective video interface cards have common connectors.

4. The medical support control system according to claim 1, wherein:
the switching control card determines an output destination for the common signal by detecting a position of a video interface card on the basis of identification information of the video interface card set as an output destination from an external environment, using video interface related information, obtained from the respective video interface cards, containing identification information used for identifying the respective video interface cards and position information specifying a position of the video interface card.

5. A plurality of video interface cards that are detachable from the medical support control system that is able to control a medical device and that are used for the medical support control system, comprising:
an input processing unit for inputting a video signal and an output processing unit for outputting a video signal;
a signal conversion unit for converting a common signal into the video signal and vice versa, said common signal being different from any video signals input into and output from the plurality of video interface cards and said common signal being used commonly in the medical support control system; and
a common signal input/output unit for inputting and outputting the common signal obtained by the conversion.
